(19) United States
(12) Patent Application Publication
(10) Pub. No.: US 2021/0274338 A1
(43) Pub. Date: Sep. 2, 2021

(54) MAINTAINING CONTACT INFORMATION OF A DATA RECORD IN A CONTACT DATABASE

(71) Applicant: QUALCOMM Incorporated, San Diego, CA (US)

(72) Inventor: Abhilash Singh RAJPOOT, Hyderabad (IN)

(21) Appl. No.: 16/804,131

(22) Filed: Feb. 28, 2020

(51) Int. Cl. H04W 8/18; H04M 1/725; H04M 1/27457

(52) U.S. Cl. CPC H04W 8/183; H04M 1/27457; H04M 1/72583

(57) ABSTRACT

Methods and computing devices implementing the methods maintain an information interface for contact information that includes temporal information related to when information elements within a contact record were last updated. The computing device may receive contact information for a field of a data record in a contact database and determine whether the contact information differs from previously stored contact information. In response to determining that the contact information differs from the previously stored contact information, the computing device may store the contact information and a time stamp in the data record. The time stamp may indicate when the contact information is stored.

### BACKGROUND

Modern computing devices, like cellphones, laptops, tablets, and desktops, have no provisions for distinguishing contact database information based on when it was recorded. Thus, users accessing a contact record have no way of easily determining which records are newest and/or which records are oldest.

### SUMMARY

Various aspects include methods and computing devices implementing methods executed by a processor of a computing device for maintaining an information interface for contact information that includes temporal information related to when information elements within a contact record were last updated. Various aspect methods may be implemented on a computing device having a display, a memory, and a processor coupled to the display and the memory. Various aspects may include receiving contact information for a field of a data record in a contact database and determining whether the contact information differs from previously stored contact information, storing, in the data record, the contact information and a time stamp indicating when the contact information is stored in response to determining that the contact information differs from previously stored contact information. In some aspects, storing the contact information and the time stamp may include maintaining an indication in the data record of when the previously stored contact information was stored in the data record.

Some aspects may further include generating the time stamp in response to receiving an instruction to store the contact information in the data record. In some aspects, storing the contact information and the time stamp may include maintaining an indication in the data record of when the previously stored contact information was stored in the data record.

Some aspects may further include displaying the contact information and a value reflecting the time stamp. Some aspects may further include displaying previous contact information with a corresponding time stamp indicating when the previous contact information was previously stored in the data record together with the displayed contact information and the corresponding time stamp.

Some aspects may further include displaying the contact information with an indication as to whether the contact information is newer than the previously stored contact information. In such embodiments, the indication as to whether the contact information is newer than the previously stored contact information may include a symbol that denotes the contact information is newer than the previously stored contact information.

Further aspects include a computing device including a memory, a display, and a processor configured with processor-executable instructions to perform operations of any of the methods summarized above. Further aspects include a non-transitory processor-readable storage medium having stored thereon processor-executable software instructions configured to cause a processor to perform operations of any of the methods summarized above. Further aspects include a processing device for use in a computing device and configured to perform operations of any of the methods summarized above. Further aspects include a computing device having means for performing functions of any of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIGS. 1A-1D are schematic diagrams illustrating a computing device maintaining an information interface for contact information in accordance with various embodiments.

FIG. 2 is a block diagram illustrating components of an example system in a package for use in a computing device in accordance with various embodiments.

FIG. 3 is a component block diagram of an example system configured for maintaining an information interface for contact information in accordance with various embodiments.

FIGS. 4A, 4B, 4C, 4D, and/or 4E are process flow diagrams of example methods for maintaining an information interface for contact information according to various embodiments.

FIG. 5 is a component block diagram of a network computing device suitable for use with various embodiments.

FIG. 6 is a component block diagram of a wireless device suitable for use with various embodiments.

### DETAILED DESCRIPTION

Various aspects will be described in detail with reference to the accompanying drawings. Wherever possible, the same reference numbers will be used throughout the drawings to refer to the same or like parts. References made to particular examples and embodiments are for illustrative purposes and are not intended to limit the scope of the various aspects or the claims.

Various embodiments provide methods that may be executed by a processor of a computing device for maintaining an information interface for contact information that includes temporal information related to when information elements within a contact record were last updated. In various embodiments, a processor of a computing device may receive contact information for a field of a data record in a contact database, and store that contact information in the data record along with a time stamp associated with the contact information and the field. Each data record in the contact database may correspond to a separate contact and may include more than one element of contact information for each field or category of data, such as two phone numbers or addresses for the same person. Various embodiments may display, on the computing device, an indication (e.g., a date) of when each of the one or more elements of contact information were stored in the data record or an indication regarding which of the one or more elements of contact information is newest or oldest. In order to avoid duplicate entries, some embodiments may refrain from storing contact information for a particular field of a data record unless that contact information differs from previously stored contact information for the same field of the data record.

As used herein, the term “contact information” refers to data, facts, or details identifying an individual or organization and indicating one or more alphanumeric sequences (i.e., numbers, letters, and/or symbols), or addresses for reaching, contacting, or locating the individual or organization. For example, contact information may include name(s), address(es), telephone numbers, or the like. Such contact information may be stored in a contact database, which may be accessed using a computing device.

As used herein, the term “contact database” refers to a software program that enables users to easily store and find contact information. A contact database may include a plurality of data records, each associated with one individual or organization. The contact database may include more than one data record for the same individual or organization, but each data record may include more than one field associated with different types of contact information. The fields in a data record may include, for example, name (i.e., of the associated individual or organization), title, related name (i.e., nickname or user name), phone number, email address, physical address, mailing address, URL, date of birth or other date, social profile or other account identifier, notes, images, videos, audio files, ringtones, text-tones, etc. In addition, one data record may include more than one field associated with the same type of contact information. For example, one data record may have multiple phone numbers or multiple addresses, each associated with a separate field for the one individual associated with that data record.

As used herein, the term “time stamp” is used herein to refer generally to temporal information regarding a time and/or date of the occurrence of a particular event, such as the storing of a particular element of contact information in a contact database. Temporal information may be stored in memory within or linked to a field of a data record of a contact database in a variety of data structures and formats, and therefore, the term “time stamp” is not intended to infer or limit the scope of the claims to a particular temporal data structure.

As used herein, the term “computing device” refers to an electronic device equipped with at least a processor, communication systems, and memory configured with a contact database. For example, computing devices may include any one or all of cellular telephones, smartphones, portable computing devices, personal or mobile multi-media players, laptop computers, tablet computers, 2-in-1 laptop/table computers, smartbooks, ultrabooks, palmtop computers, wireless electronic mail receivers, multimedia Internet-enabled cellular telephones, wearable devices including smart watches, entertainment devices (e.g., wireless gaming controllers, music and video players, satellite radios, etc.), and similar electronic devices that include a memory, wireless communication components and a programmable processor. In various embodiments, computing devices may be configured with memory and/or storage. Additionally, computing devices referred to in various example embodiments may be coupled to or include wired or wireless communication capabilities implementing various embodiments, such as network transceiver(s) and antenna(s) configured to communicate with wireless communication networks.

The term “system on chip” (SOC) is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package” (SIP) may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

Various embodiments enable users of a computing device to readily identify which contact information is newer and/or older than other contact information in a field of a data record in a contact database. In particular, various embodiments store temporal information, referred to generally herein as a time stamp, that corresponds to or identifies when the information in each field of the data record was stored in the data record. The time stamps enable the contact information within each field to be displayed on the computing device with an indication as to whether that contact information is newer than other stored contact information. For example, the indication may be a symbol that denotes the contact information is newer than other stored contact information of the same type. Alternatively, the indication may be a value reflecting the time stamp itself (e.g., a date, time, or another temporal value). Some embodiments may display previous contact information with a corresponding time stamp, indicating when the previous contact information was stored in the data record together with the display of newer contact information and a corresponding time stamp for the newer contact information.

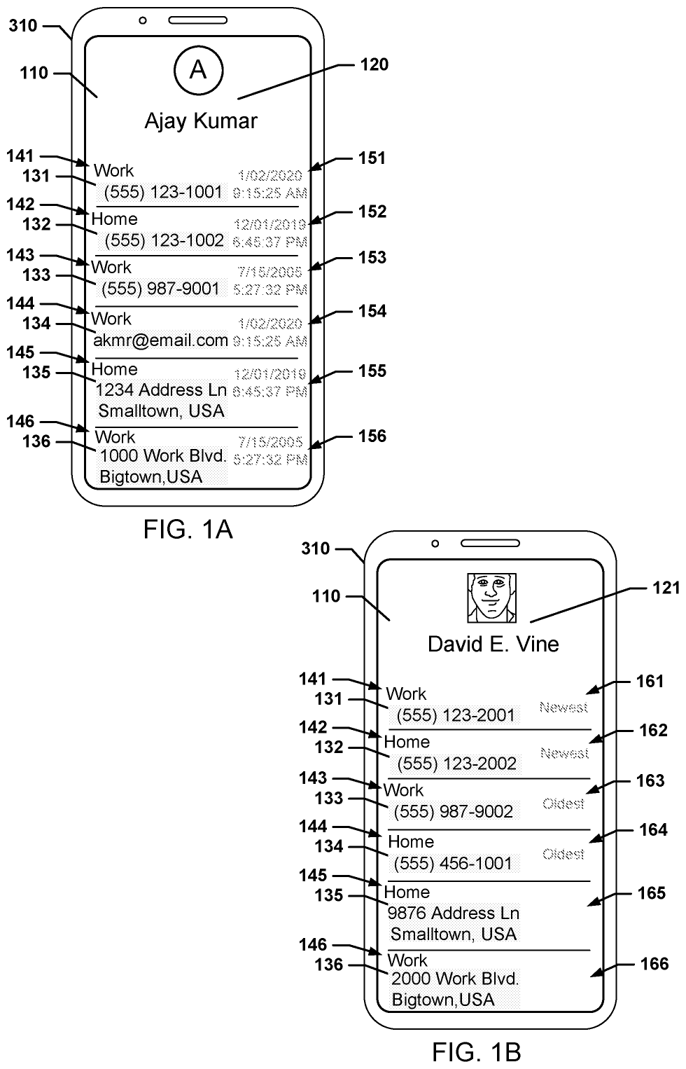

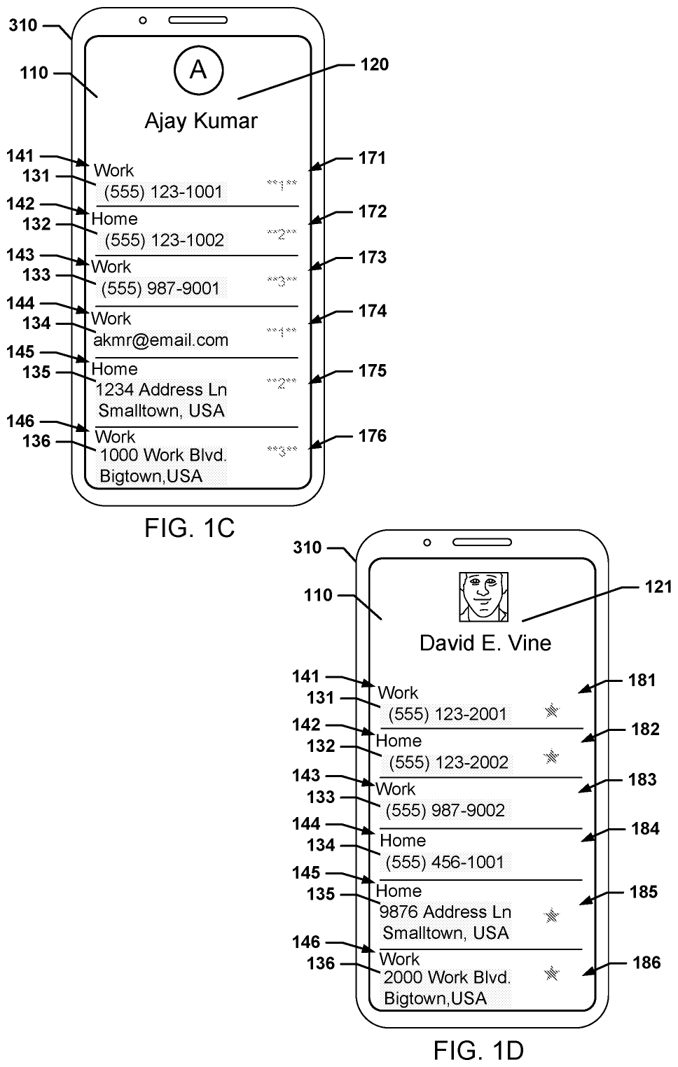

FIGS. 1A-1D illustrate an example computing device 310 that is suitable for implementing various embodiments. The computing device 310, controlled by one or more processors, includes a display 110 configured to present text, graphics, images, and video, at least temporarily, for viewing. The display 110 may be a visual display screen as well as a touch-sensitive input screen. Alternatively, the computing device 310 may include or work in conjunction with other input devices, like a keyboard, mouse, microphone, etc. (i.e., through a wired or wireless connection), for receiving user inputs. In addition, the computing device 310 may receive an input and transmit an output through a wireless transceiver. In accordance with various embodiments, the display 110 may be configured to present information from an application or program for managing contact information (sometimes referred to herein as a “contacts application”). The contacts application may present various elements of contact information from data records of a contact database, which may include data records for numerous contacts. The contact database, including the contact information stored therein, may be stored locally in the computing device 310 and/or in a remote computing device, such as a remote server.

Each of FIGS. 1A-1D show a data record for a contact from the contact database, which includes various elements of contact information displayed in each of several primary fields 131, 132, 133, 134, 135, 136 with one or more related fields, such as the data label fields 141, 142, 143, 144, 145, 146. In accordance with various embodiments, each primary field 131, 132, 133, 134, 135, 136 may also include one or more additional related fields, namely time stamp indication fields. The time stamp indication fields may include an indication of when the contact information was stored in the data record. FIGS. 1A-1D each illustrate displayed contact information that includes different versions of the time stamp indication fields.

The data label fields 141, 142, 143, 144, 145, 146 may include a label for a corresponding primary field to which that data label field is associated. For example, the data label fields 141, 142, 143, 144, 145, 146 may comprise a label selected from a list including “Home,” “Work,” “School,” “Mobile,” “Main,” “Fax,” “Pager,” “Other,” or a custom label. The labels selected for the data label field 141, 142, 143, 144, 145, 146 may help users organize and distinguish contact information of the same type. For example, when a contact, such as the contact 120, includes more than one phone number, using labels, like “Work” or “Home” may help distinguish such contact information. Additionally, or alternatively, the data label field 141, 142, 143, 144, 145, 146 may include added descriptors of the type of information included in the corresponding primary field 131, 132, 133, 134, 135, 136. For example, the data label field 141, 142, 143, 144, 145, 146 may include descriptors, such as “Phone,” “email,” “address,” etc., following the other labels noted above (e.g., “Home Phone,” “Work Address,” or “Personal Webpage”). However, often contact information like phone numbers, email, or other addresses are self-evident and do not need such added descriptors.

FIG. 1A illustrates an example of a data record for one of the contacts, namely contact 120 (i.e., “Ajay Kumar”). In the illustrated example, the primary fields 131, 132, 133, 134, 135, 136 each include an associated time stamp indication field 151, 152, 153, 154, 155, 156. The time stamp indication fields 151, 152, 153, 154, 155, 156 in the illustrated example include an indication as to when the contact information was stored in the data record, particularly the value of the corresponding time stamp. The value of the time stamp may include a time (e.g., hour, minutes, seconds) and a date reflecting when the contact information was stored in the data record. Alternatively, an abbreviated or translated version of the value of the corresponding time stamp may be displayed in the time stamp indication fields 151, 152, 153, 154, 155, 156. For example, the time stamp indication fields 151, 152, 153, 154, 155, 156 may display less than the full value of the time stamp, such as the date but not the time, less than the full date, such as the month and year only, or the like.

In various embodiments, the contact information displayed for the data record of the contact 120 may reveal that, based on the displayed time stamps in the time stamp indication fields 151, 152, 153, 154, 155, 156, one or more of the primary fields (e.g., the primary fields 131, 134) include(s) contact information that is newer than the contact information included in the other primary fields (e.g., the primary fields 132, 133, 135, 136). In addition, within one data record, some primary fields may correspond to the same type of contact information, which may make the display of the time stamp indication field particularly useful. For example, the contact 120 includes three phone numbers (i.e., the same type of contact information) in the first three primary fields 131, 132, 133, in which the first and third data label fields 141, 143 are labeled “Work,” while the second data label field 142 is labeled “Home.” Thus, a user viewing the display 110 may find the first and third time stamp indication fields 151, 153 useful for determining which of those corresponding two phone numbers is the most current. In particular, the first time stamp indication field 151 (i.e., “1/02/2020 9:15:25 AM”) is associated with newer contact information in the first primary field 131 than the third time stamp indication field 153 (i.e., “7/15/2005 5:27:32 PM”), which is associated with older contact information. In contrast, the contact 120 includes two mailing/street addresses that are not the same type of contact information. In particular, the second to last primary field 135 has a corresponding data label field 145 labeled “Home,” while the last primary field 136 has a corresponding data label field 146 is labeled “Work.” Although these two fields of contact information are not precisely the same type, the user viewing the display 110 may still use the corresponding time stamp indication fields 155, 156 to determine which of the two addresses are most recently saved.

FIG. 1B illustrates the data record for another contact, namely contact 121 (i.e., “David E. Vine”). In accordance with various embodiments, the primary fields 131, 132, 133, 134, 135, 136 may include an associated time stamp indication field that displays an indication as to whether the related primary field includes contact information that is newer than other primary field contact information. In this illustrative example, two of the primary fields 131, 132, include time stamp indication fields 161, 162 that display the term “Newest,” which indicates those corresponding primary fields 131, 132 include the newest contact information, at least as compared to other primary fields with the same type of contact information (i.e., primary fields 133, 134, which are telephone numbers of a particular type, such as a “Work” telephone number or a “Home” telephone number). In contrast to the first two primary fields 161, 162, the third and fourth primary fields 133, 134 include time stamp indication fields 163, 164 that display the term “Oldest.” The term “Oldest” indicates those corresponding primary fields 133, 134 include the oldest contact information, at least as compared to other primary fields with the same type of contact information (i.e., primary fields 131, 132).

In addition, two more of the primary fields 135, 136, include time stamp indication fields 165, 166 that are blank, which in a way still indicates whether the related primary fields include contact information that is newer than other primary field contact information. A blank time stamp indication field may represent that no other primary field of the same type is included for that contact 121. In this way, the last two primary fields 135, 136 may be said to include the newest contact information relative to other primary fields.

FIG. 1C illustrates another embodiment of the display of the data record for the contact 120 (i.e., “Ajay Kumar”). In accordance with various embodiments, the contact information in the primary fields 131, 132, 133, 134, 135, 136 is displayed along with a numeral that indicates whether the contact information is newer than other contact information that is also displayed. The lower the number displayed in the time stamp indication field, the newer the contact information is in the related primary field. For example, two of the primary fields 131, 134 with the newest data, include time stamp indication fields 171, 174 that display the number one (1) surrounded by pairs of asterisks (i.e., “**1**”). Using the number one as the lowest number displayed in the time stamp indication fields indicates those corresponding primary fields 131, 134 include the newest contact information compared to all the other primary fields (i.e., primary fields 132, 133, 135, 136). In contrast, two of the primary fields 133, 136 with the oldest data, include time stamp indication fields 173, 176 that display the number three (3) surrounded by pairs of asterisks (i.e., “**3**”). Similarly, two of the primary fields 132, 135 with neither the newest nor the oldest data, include time stamp indication fields 172, 175 that display the number two (2) surrounded by pairs of asterisks (i.e., “**3**”). Two or more of the time stamp indication fields displaying the same value may reflect the fact that both values were saved at the same time. The display of an even higher number (i.e., higher than 3) in the time stamp indication fields may designate an even older element of contact information.

In accordance with various embodiments, other numeric values or schemes may be used to reflect whether individual fields from a data record contain newer or older contact information. For example, a highest value may represent the newest data entry (e.g., 10 out of 10). Similarly, although asterisks are used to accentuate and differentiate the value displayed in the time stamp indication fields 171, 172, 173, 174, 175, 176, other visual aids may be employed (e.g., using bold, italic, underline, color, highlighting, a different font, etc.).

FIG. 1D illustrates another embodiment of the display of the data record for the other contact 121 (i.e., “David E. Vine”). In accordance with various embodiments, the contact information in the primary fields 131, 132, 133, 134, 135, 136 is displayed along with a symbol (i.e., a star) in the corresponding time stamp indication fields that indicates whether the corresponding contact information is the newest contact information of that particular type of contact information. As used herein, the term “symbol” refers to a mark or character used as a representation of the indication that corresponding contact information is the newest contact information of that particular type of contact information. In this illustrative example, four of the primary fields 131, 132, 135, 136 include time stamp indication fields 181, 182, 185, 186 that display a star (i.e., “★”), which indicates those corresponding primary fields 131, 132, 135, 136 include the newest contact information of that type. In contrast, the other two time stamp indication fields 183, 184 are blank (i.e., do not include a star), which indicates those corresponding primary fields 133, 134 include older contact information of that type.

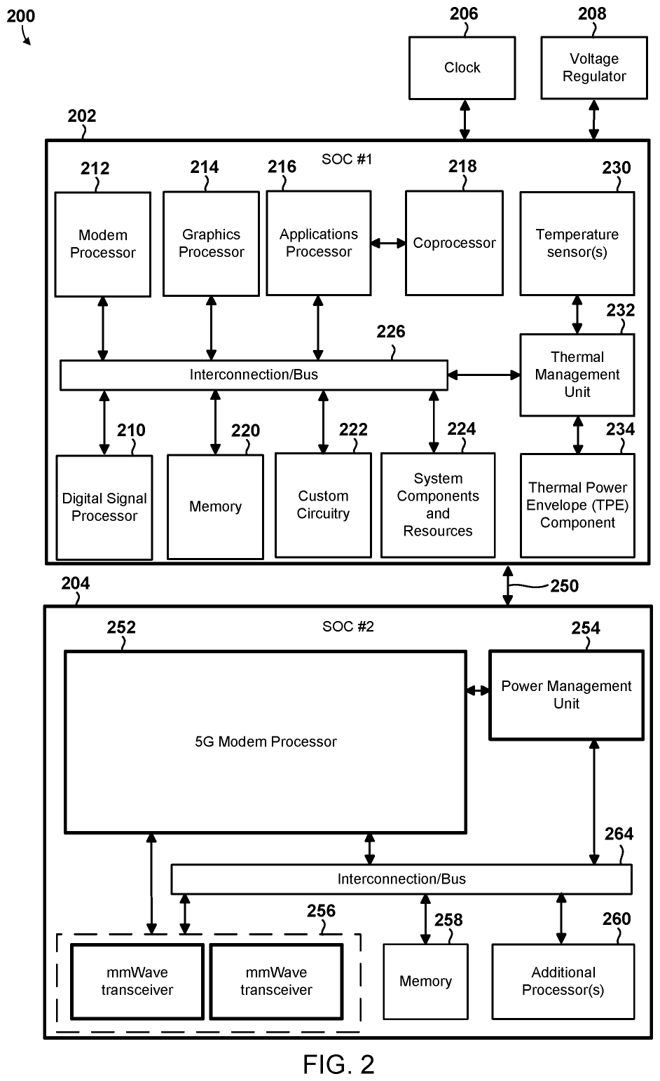

Various embodiments may be implemented using a number of single processor and multiprocessor computer systems, including a system-on-chip (SOC) or system in a package (SIP). FIG. 2 illustrates an example computing system or SIP 200 architecture that may be used in wireless devices implementing the various embodiments.

With reference to FIGS. 1 and 2, the illustrated example SIP 200 includes a two SOCs 202, 204, a clock 206, and a voltage regulator 208. In some embodiments, the first SOC 202 operates as central processing unit (CPU) of the wireless device that carries out the instructions of software application programs by performing the arithmetic, logical, control and input/output (I/O) operations specified by the instructions. In some embodiments, the second SOC 204 may operate as a specialized processing unit. For example, the second SOC 204 may operate as a specialized 5G processing unit responsible for managing high volume, high speed (e.g., 5 Gbps, etc.), and/or very high frequency short wave length (e.g., 28 GHz mmWave spectrum, etc.) communications.

The first SOC 202 may include a digital signal processor (DSP) 210, a modem processor 212, a graphics processor 214, an application processor 216, one or more coprocessors 218 (e.g., vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (e.g., FreeBSD, LINUX, OS X, etc.) and a processor that executes a second type of operating system (e.g., MICROSOFT WINDOWS 10). In addition, any or all of the processors 210, 212, 214, 216, 218, 252, 260 may be included as part of a processor cluster architecture (e.g., a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 and/or custom circuitry 222 may also include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates and/or implement a bus architecture (e.g., CoreConnect, AMBA, etc.). Communications may be provided by advanced interconnects, such as high-performance networks-on chip (NoCs).

The first and/or second SOCs 202, 204 may further include an input/output module (not illustrated) for communicating with resources external to the SOC, such as a clock 206 and a voltage regulator 208. Resources external to the SOC (e.g., clock 206, voltage regulator 208) may be shared by two or more of the internal SOC processors/cores.

In addition to the example SIP 200 discussed above, various embodiments may be implemented in a wide variety of computing systems, which may include a single processor, multiple processors, multicore processors, or any combination thereof.

As used herein, the terms “component,” “system,” “unit,” “module,” and the like include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known computer, processor, and/or process related communication methodologies.

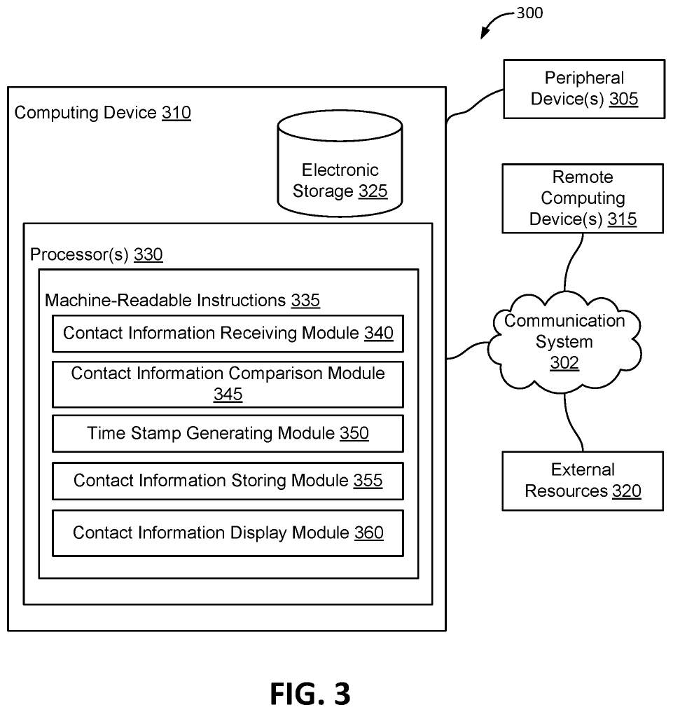

FIG. 3 is a component block diagram illustrating a system 300 configured for maintaining an information interface for contact information executed by a processor of a computing device in accordance with various embodiments. In some embodiments, system 300 may include a computing device 310 and/or one or more remote computing device(s) 315. With reference to FIGS. 1-3, the computing device 310 may be communicatively coupled to peripheral device(s) 305, and configured to communicate with remote computing device(s) 315 and/or external resources 320 via a communication system 302, such as a cellular wireless communication network.

The computing device 310 may include electronic storage 325, one or more processors 330, and/or other components. The computing device 310 may include communication lines, or ports to enable the exchange of information with a network and/or other computing platforms. Illustration of the computing device 310 in FIG. 3 is not intended to be limiting. The computing device 310 may include a plurality of hardware, software, and/or firmware components operating together to provide the functionality attributed herein to the computing device 310.

Electronic storage 325 may comprise non-transitory storage media that electronically stores information. The electronic storage media of electronic storage 325 may include one or both of system storage that is provided integrally (i.e., substantially non-removable) with the computing device 310 and/or removable storage that is removably connectable to the computing device 310 via, for example, a port (e.g., a universal serial bus (USB) port, a firewire port, etc.) or a drive (e.g., a disk drive, etc.). Electronic storage 325 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 325 may include one or more virtual storage resources (e.g., cloud storage, a virtual private network, and/or other virtual storage resources). Electronic storage 325 may store software algorithms, information determined by processor(s) 330, information received from the computing device 310, information received from remote platform(s) 304, and/or other information that enables the computing device 310 to function as described herein.

Processor(s) 330 may be configured to provide information processing capabilities in the computing device 310. As such, processor(s) 330 may include one or more of a digital processor, an analog processor, a digital circuit designed to process information, an analog circuit designed to process information, a state machine, and/or other mechanisms for electronically processing information. Although processor(s) 330 is shown in FIG. 3 as a single entity, this is for illustrative purposes only. In some implementations, processor(s) 330 may include a plurality of processing units. These processing units may be physically located within the same device, or processor(s) 330 may represent processing functionality of a plurality of devices operating in coordination.

The computing device 310 may be configured by machine-readable instructions 335, which may include one or more instruction modules. The instruction modules may include computer program modules. In particular, the instruction modules may include one or more of a contact information receiving module 340, contact information comparison module 345, time stamp generating module 350, contact information storing module 355, contact information display module 360, and/or other instruction modules.

The contact information receiving module 340 may be configured to receive contact information for a field of a data record in a contact database. The contact information receiving module 340 may receive contact information from a remote source, such as a remote system (e.g., 315) or external resources (e.g., 320), using a transceiver (e.g., 256) and related components. The contact information may be received through direct user input, messages (e.g., e-mails), multimedia messaging services (MMS), instant messaging (IM), Quick Response (QR) code, or other data exchange system. The contact information may be received in various formats, such as a virtual contact file (vCard) or the like.

The contact information comparison module 345 may be configured to determine whether newly received contact information differs from previously stored contact information. To make the comparison, the contact information comparison module 345 may access a contact database, containing one or more data records, stored in local memory (e.g., 220, 258) or in a remote source, such as a remote system (e.g., 315) or external resources (e.g., 320) via the communication system 302 using a transceiver (e.g., 256) and related components. In accessing the contact database, the contact information comparison module 345 may scan the existing stored contact information fields for a match to any newly received contact information. Once the contact information comparison module 345 performs a comparison, the contact information comparison module 345 may output a determination as to whether the newly received contact information differs from any previously stored contact information.

The time stamp generating module 350 may be configured to generate a time stamp indicating when the contact information is stored in the data record in response to determining that the contact information differs from the previously stored contact information. The time stamp generating module 350 may generate the time stamp using a standardized digital format.

The contact information storing module 355 may be configured to store, in the data record of the contact database, the contact information and time stamp. The contact information storing module 355 may store the contact information and time stamp in the local memory (e.g., 220, 258) or at a remote source, such as the remote system (e.g., 315) or external resources (e.g., 320) using the transceiver (e.g., 256) and related components. Storing the contact information and time stamp may include maintaining an indication in the data record of when the previously stored contact information was previously stored in the data record.

The contact information display module 360 may be configured to display various elements of contact information. For example, the contact information display module 360 may display the primary field contact information (e.g., 131, 132, 133, 134, 135, 136), the data label fields (e.g., 141, 142, 143, 144, 145, 146), and the time stamp indication fields 151-156, 161-166, 171-176, and 181-186. In addition, the contact information display module 360 may be configured to display previous contact information with a corresponding time stamp. In this way, the display of the different contact information with corresponding time stamps will provide an indication as to when the previous contact information was stored in the data record together with newer displayed contact information. Further, the contact information display module 360 may be configured to display the contact information with one or more types of indications as to whether the contact information is newer than the previously stored contact information. For example, the indication as to whether a particular field of contact information is newer than another may be displayed in the form of a symbol that denotes the contact information is newer than other contact information (i.e., previously stored contact information). The contact information display module 360 may display the contact information and value reflecting the time stamp using a display (e.g., 110) of the computing device (e.g., 310).

In some implementations, the computing device 310, peripheral device(s) 305, remote computing devices 315, and/or external resources 320 may be operatively linked via a communication system 302. For example, the communication system 302 may be a cellular or wireless communication network.

A given remote computing device 315 may include one or more processors configured to execute computer program modules similar to those in the machine-readable instructions 335 described above. By way of non-limiting examples, remote computing devices may include one or more of a desktop computer, a laptop computer, a handheld computer, a tablet computing platform, a NetBook, a Smartphone, a gaming console, and/or other computing platforms.

External resources 320 may include remote servers storing a contacts database (or a backup copy of a contacts database), sources of information outside of system 300, external entities participating with system 300, and/or other resources. In some implementations, some or all of the functionality attributed herein to external resources 320 may be provided by resources included in system 300.

The processor(s) 330 may be configured to execute modules 340, 345, 350, 355, and/or 360, and/or other modules. Processor(s) 330 may be configured to execute modules 340, 345, 350, 355, and/or 360, and/or other modules by software; hardware; firmware; some combination of software, hardware, and/or firmware; and/or other mechanisms for configuring processing capabilities on processor(s) 330. As used herein, the term “module” may refer to any component or set of components that perform the functionality attributed to the module. This may include one or more physical processors during execution of processor readable instructions, the processor readable instructions, circuitry, hardware, storage media, or any other components.

The description of the functionality provided by the different modules 340, 345, 350, 355, and/or 360 described below is for illustrative purposes, and is not intended to be limiting, as any of modules 340, 345, 350, 355, and/or 360 may provide more or less functionality than is described. For example, one or more of modules 340, 345, 350, 355, and/or 360 may be eliminated, and some or all of its functionality may be provided by other ones of modules 340, 345, 350, 355, and/or 360. As another example, processor(s) 330 may be configured to execute one or more additional modules that may perform some or all of the functionality attributed below to one of modules 340, 345, 350, 355, and/or 360.

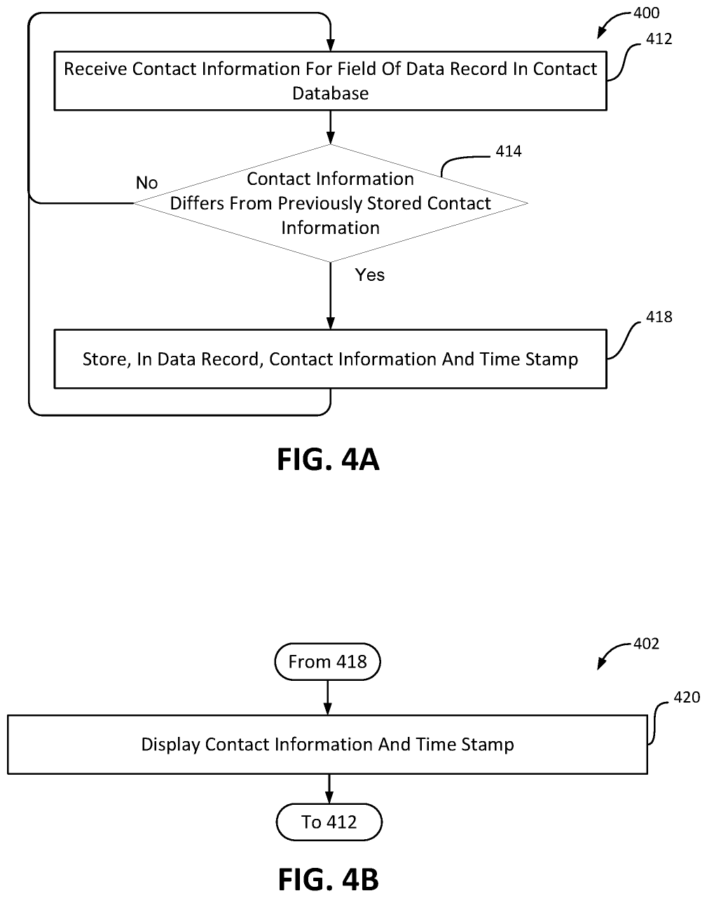

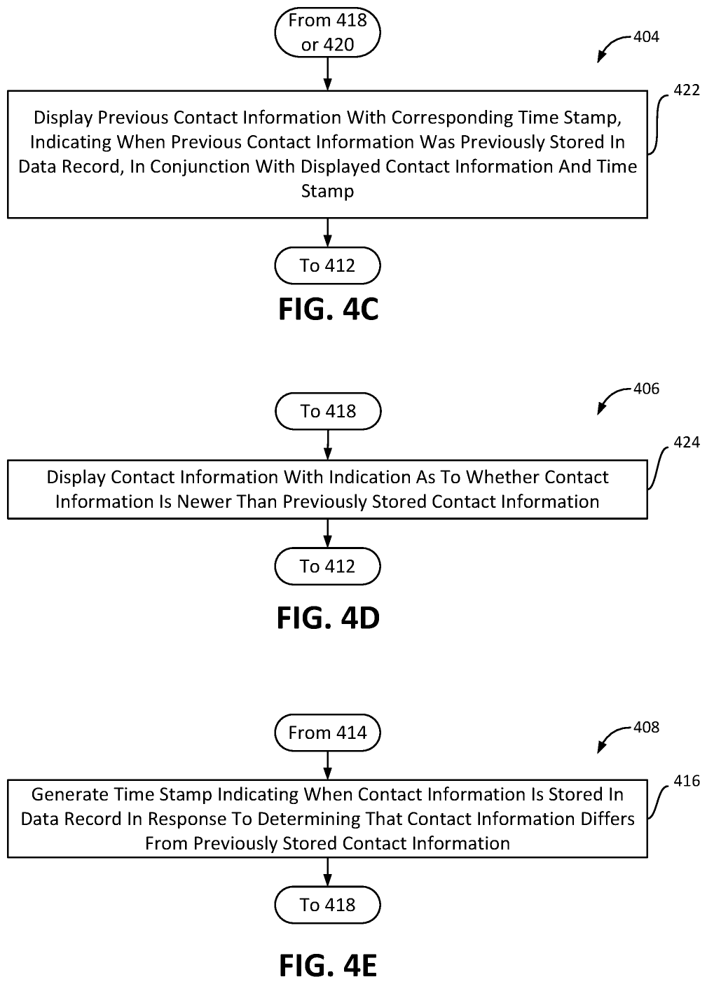

FIGS. 4A, 4B, 4C, 4D, and/or 4E illustrate(s) operations of methods 400, 402, 404, 406, and 408 for maintaining an information interface for contact information in accordance with various embodiments. With reference to FIGS. 1-4A, 4B, 4C, 4D, and/or 4E, the operations of the methods 400, 402, 404, 406, and 408 presented below are intended to be illustrative. In some embodiments, the methods 400, 402, 404, 406, and 408 may be accomplished with one or more additional operations not described, and/or without one or more of the operations discussed. Additionally, the order in which the operations of the methods 400, 402, 404, 406, and 408 are illustrated in FIGS. 4A, 4B, 4C, 4D, and/or 4E and described below is not intended to be limiting.

In various embodiments, the methods 400, 402, 404, 406, and 408 may be implemented in one or more processors (e.g., a digital processor, an analog processor, a digital circuit designed to process information, an analog circuit designed to process information, a state machine, and/or other mechanisms for electronically processing information) in response to instructions stored electronically on an electronic storage medium of a computing device. The one or more processors may include one or more devices configured through hardware, firmware, and/or software to be specifically designed for execution of one or more of the operations of the methods 400, 402, 404, 406, and 408. For example, with reference to FIGS. 1-4A, 4B, 4C, 4D, and/or 4E, the operations of the methods 400, 402, 404, 406, and 408 may be performed by a processor (e.g., 202, 204, 210, 212, 214, 216, 218, 252, 260) of a computing device (e.g., 310).

FIG. 4A illustrates a method 400 by which the processor of a computing device may maintain an information interface for contact information that provides temporal information related to when contact information was stored in contact database data records.

In block 412, the processor may perform operations including receiving contact information for a field of a data record in a contact database. In block 412, the processor may receive contact information, such as a name (e.g., formal name, nickname, user name, business name, alias, title, etc.), address (e.g., e-mail, web, mailing, postal, etc.), and/or numbers (e.g., telephone, account, etc.) from one or more input sources. For example, a user may use a touch-sensitive input screen (e.g., 110) other input devices, like a keyboard, mouse, microphone, etc. (e.g., 305). As a further example, the computing device may receive contact information from a remote source, such as a remote system (e.g., 315) or external resources (e.g., 320), using a transceiver (e.g., 256) and related components. The contact information may be received via user input or through messages (e.g., e-mails), multimedia messaging services (MMS), instant messaging (IM), QR code, or other data exchange system. The contact information may be received in various formats, such as a virtual contact file (vCard) or the like.

In determination block 414, the processor may perform operations including determining whether the contact information differs from previously stored contact information. To make the determination in block 404, the processor may access a contact database, containing one or more data records, stored in local memory (e.g., 220, 258) or from a remote source, such as a remote system (e.g., 315) or external resources (e.g., 320) using a transceiver (e.g., 256) and related components. In accessing the contact database, the processor may scan the existing stored contact information fields for a match to the contact information received in block 402. An existing stored contact information field and the received contact information may be considered a match if they are identical. Alternatively, slight variations between the existing stored contact information field and the received contact information may be considered a match. For example, a matching logic engine may be employed that used statistical analysis for identifying matches above a certain threshold.

As part of making the determination in block 414, the processor may limit matches to primary field contact information (e.g., 131, 132, 133, 134, 135, 136). For example, only primary field contact information may be scanned for matches. In addition, the processor may use the data label fields (e.g., 141, 142, 143, 144, 145, 146) or data format information (e.g., the data is a phone number, email address, text field, etc.) for determining matches. Thus, only primary field contact information that also has a matching data label field or is presented in the same format may be considered a match (i.e., does not differ).

In response to determining that the contact information does not differ from (i.e., is a match to) the previously stored contact information (i.e., determination block 414=“No”), the processor may repeat the operations in block 412 to await receipt of additional contact information.

In response to determining that the contact information differs from the previously stored contact information (i.e., determination block 414=“Yes”), the processor may perform operations including storing, in the data record of the contact database, the contact information and time stamp in block 418. The time stamp may reflect a value that corresponds to a time and/or date when the contact information is being stored in the data record of the contact database. For example, the time stamp may include a date and time (e.g., hours, minutes, seconds). Alternatively, the time stamp may be less granular, such as one that only includes the date, only includes the month and year, or only includes the year. The time stamp may be saved in any format that is readable and/or translatable by the processor for later display as an indication as to whether that contact information is newer or older than other stored contact information.

In block 418, the processor may store the contact information and time stamp in the local memory (e.g., 220, 258) or at a remote source, such as the remote system (e.g., 315) or external resources (e.g., 320) using the transceiver (e.g., 256) and related components. The time stamp may be saved in a consistent format, allowing for easy later comparison of two different records.

Following the operations in block 418, the processor may await receipt of additional contact information before repeating the operations in block 412.

FIG. 4B illustrates a method 402 for displaying contact information including time stamp information, which may be performed after the operations in block 418, or may be performed in a separate implementation.

In block 420, the processor may perform operations including displaying the contact information along with the associated time stamps. The contact information and time stamp may be displayed in various formats. For example, the time stamp may be displayed immediately adjacent any primary field contact information (see, FIG. 1A) to indicate when the primary field contact information was stored in the record of the contact database. Following the operations in block 420, the processor may await receipt of additional contact information before repeating the operations in block 412. In some embodiments, means for performing the operations in block 420 may include the processor (e.g., 202, 204, 210, 212, 214, 216, 218, 252, 260), memory (e.g., 220, 258) and a display (e.g., 110) of the computing device (e.g., 310).

FIG. 4C illustrates a method 404 for displaying contact information including time stamp information for previous contact information, which may be performed after the operations in block 418 or block 420, or may be performed in a separate implementation.

In block 422, the processor may perform operations including displaying previous contact information with a corresponding time stamp, indicating when the previous contact information was previously stored in the data record together with the displayed contact information and time stamp. The previous contact information and corresponding time stamp may be displayed in various formats. For example, the corresponding time stamp may be displayed immediately adjacent the previous contact information (see, FIG. 1A) to indicate when the previous contact information was stored in the record of the contact database. Following the operations in block 422, the processor may await receipt of additional contact information before repeating the operations in block 412. In some embodiments, means for performing the operations in block 422 may include the processor (e.g., 202, 204, 210, 212, 214, 216, 218, 252, 260) and a display (e.g., 110) of the computing device (e.g., 310).

FIG. 4D illustrates method 406 for displaying contact information including whether the contact information is newer than previously stored information, which may be performed after the operations in block 418, or may be performed in a separate implementation.

In block 424, the processor may perform operations including displaying the contact information with an indication as to whether the contact information is newer than the previously stored contact information. The contact information and indication as to whether the contact information is newer than the previously stored contact information may be displayed in various formats. For example, the indication as to whether the contact information is newer than the previously stored contact information may be displayed immediately adjacent any primary field contact information (see, FIGS. 1A-1D) using text, numbers, and/or symbols. The text, numbers, and/or symbols may reflect an age ranking next to each of primary fields displayed. For example, a low ranking may represent the newest entries, whereas a high ranking represents the oldest entries, or vise-versa. In some embodiments, means for performing the operations in block 424 may include the processor (e.g., 202, 204, 210, 212, 214, 216, 218, 252, 260) and a display (e.g., 110) of the computing device (e.g., 310). Following the operations in block 424, the processor may await receipt of additional contact information before repeating the operations in block 412.

FIG. 4E illustrates a method 408 for generating time stamp information that may be performed as part of the method 400 following operations in determination block 414.

In response to determining that the contact information differs from previously stored contact information (i.e., determination block 414=“Yes”), the processor may perform operations including generating a time stamp indicating when the contact information is stored in the data record of the database in block 416. The processor may generate the time stamp using a standardized digital format (e.g., ISO 8601 Data elements and interchange formats—Information interchange—Representation of dates and times). In some embodiments, means for performing the operations in block 414 may include the processor (e.g., 202, 204, 210, 212, 214, 216, 218, 252, 260) of the computing device (e.g., 310). Following the operations in block 416, the processor may store, in the data record of the contact database, the contact information and time stamp in block 418.

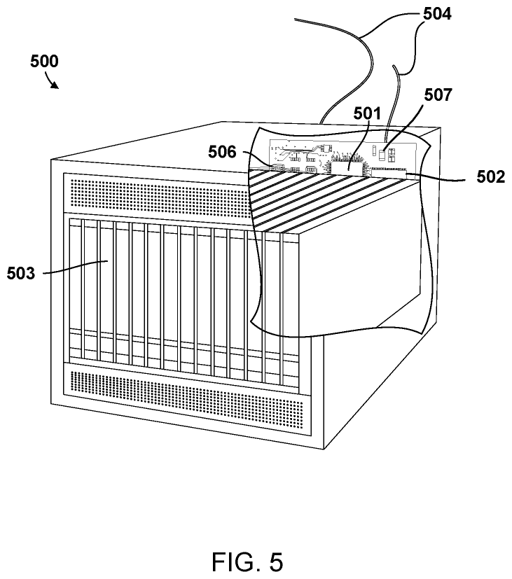

The various embodiments described with reference to FIGS. 1-4E may be implemented on a variety of computing devices, an example of which is illustrated in FIG. 5 in the form of a server. With reference to FIGS. 1-5, the network computing device 500 may include a processor 501 coupled to volatile memory 502 and a large capacity nonvolatile memory, such as a disk drive 503. The network computing device 500 may also include a peripheral p access device such as a floppy disc drive, compact disc (CD) or digital video disc (DVD) drive 506 coupled to the processor 501. The network computing device 500 may also include network access ports 504 (or interfaces) coupled to the processor 501 for establishing data connections with a network, such as the Internet and/or a local area network coupled to other system computers and servers. The network computing device 500 may include one or more antennas 507 for sending and receiving electromagnetic radiation that may be connected to a wireless communication link. The network computing device 500 may include additional access ports, such as USB, Firewire, Thunderbolt, and the like for coupling to peripherals, external memory, or other devices.

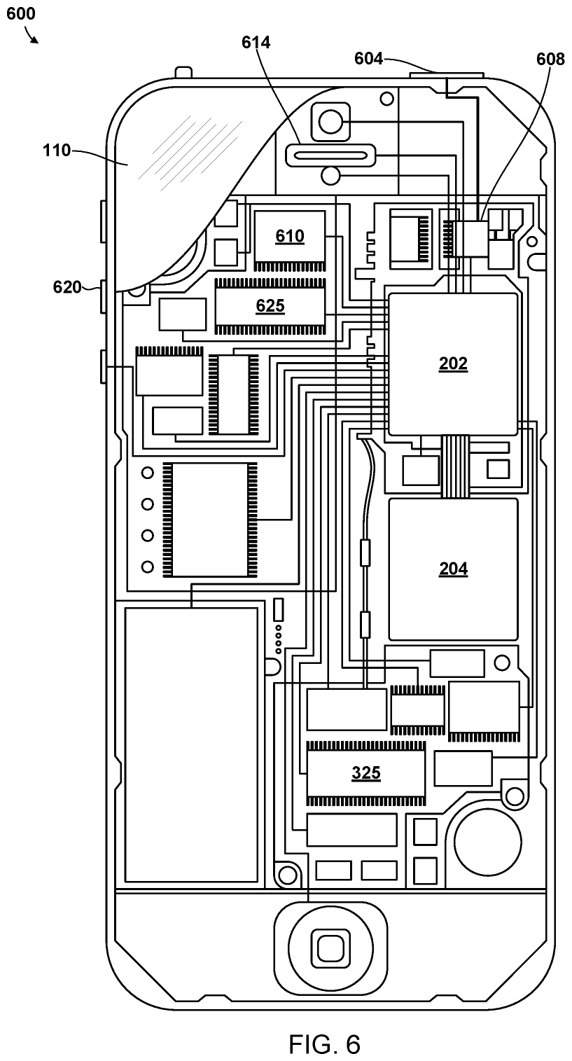

The various embodiments described with reference to FIGS. 1-4E may be implemented on a variety of mobile computing devices, an example of which is illustrated in FIG. 6 in the form of a smartphone. With reference to FIGS. 1-6, a mobile computing device 600 may include a first SoC 202 (e.g., a SoC-CPU) coupled to a second SoC 204 (e.g., a 5G capable SoC) and a third SoC 625 (e.g., a C-V2X SoC configured for managing V2V, V2I, and V2P communications over D2D links, such as D2D links establish in the dedicated Intelligent Transportation System (ITS) 5.9 GHz spectrum communications). The first, second, and/or third SoCs 202, 204, and 625 may be coupled to internal memory 325, a display 110, and to a speaker 614. Additionally, the mobile computing device 600 may include one or more antenna 604 for sending and receiving electromagnetic radiation that may be connected to one or more transceiver 608 (e.g., a wireless data link and/or cellular transceiver, etc.) coupled to one or more processors in the first, second, and/or third SoCs 202, 204, and 625. Mobile computing devices 600 may also include menu selection buttons or rocker switches 620 for receiving user inputs.

Mobile computing devices 600 may additionally include a sound encoding/decoding (CODEC) circuit 610, which digitizes sound received from a microphone into data packets suitable for wireless transmission and decodes received sound data packets to generate analog signals that are provided to the speaker to generate sound. Also, one or more of the processors in the first, second, and/or third SoCs 202, 204, and 625, transceiver 608 and CODEC circuit 610 may include a digital signal processor (DSP) circuit (not shown separately).

The processors implementing various embodiments may be any programmable microprocessor, microcomputer or multiple processor chip or chips that can be configured by software instructions (applications) to perform a variety of functions, including the functions of the various aspects described in this application. In some communication devices, multiple processors may be provided, such as one processor dedicated to wireless communication functions and one processor dedicated to running other applications. Typically, software applications may be stored in the internal memory before they are accessed and loaded into the processor. The processor may include internal memory sufficient to store the application software instructions.

As used in this application, the terms “component,” “module,” “system,” and the like are intended to include a computer-related entity, such as, but not limited to, hardware, firmware, a combination of hardware and software, software, or software in execution, which are configured to perform particular operations or functions. For example, a component may be, but is not limited to, a process running on a processor, a processor, an object, an executable, a thread of execution, a program, and/or a computer. By way of illustration, both an application running on a processor of a communication device and the communication device may be referred to as a component. One or more components may reside within a process and/or thread of execution and a component may be localized on one processor or core and/or distributed between two or more processors or cores. In addition, these components may execute from various non-transitory computer readable media having various instructions and/or data structures stored thereon. Components may communicate by way of local and/or remote processes, function or procedure calls, electronic signals, data packets, memory read/writes, and other known network, computer, processor, and/or process related communication methodologies.

A number of different cellular and mobile communication services and standards are available or contemplated in the future, all of which may implement and benefit from the various aspects. Such services and standards may include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA1020TM), EDGE, advanced mobile phone system (AMPS), digital AMPS (IS-136/TDMA), evolution-data optimized (EV-DO), digital enhanced cordless telecommunications (DECT), Worldwide Interoperability for Microwave Access (WiMAX), wireless local area network (WLAN), Wi-Fi Protected Access I & II (WPA, WPA2), integrated digital enhanced network (iden), C-V2X, V2V, V2P, V2I, and V2N, etc. Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the CLAIMS to a particular communication system or technology unless specifically recited in the claim language.

Various aspects illustrated and described are provided merely as examples to illustrate various features of the claims. However, features shown and described with respect to any given aspect are not necessarily limited to the associated aspect and may be used or combined with other aspects that are shown and described. Further, the claims are not intended to be limited by any one example aspect. For example, one or more of the operations of the methods may be substituted for or combined with one or more operations of the methods.

The foregoing method descriptions and the process flow diagrams are provided merely as illustrative examples and are not intended to require or imply that the operations of various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such aspect decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make or use the claims. Various modifications to these aspects will be readily apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

1. A method executed by a processor of a computing device for maintaining an information interface for contact information, comprising:
receiving contact information for a field of a data record of an individual or organization having a previously stored data record in a contact database;
determining whether the received contact information for the individual or organization differs from previously stored contact information for the same individual or organization; and
storing, in the data record, the received contact information and a time stamp indicating when the received contact information is stored in response to determining that the received contact information for the individual or organization differs from previously stored contact information for the same individual or organization.

2. The method of claim 1, further comprising:
generating the time stamp in response to receiving an instruction to store the received contact information in the data record.

3. The method of claim 1, further comprising:
displaying the received contact information and a value reflecting the time stamp.

4. The method of claim 3, further comprising:
displaying previous contact information with a corresponding time stamp indicating when the previous contact information was previously stored in the data record together with the received contact information displayed along with the corresponding time stamp.

5. The method of claim 1, further comprising:
displaying the received contact information with an indication as to whether the received contact information is newer than the previously stored contact information.

6. The method of claim 5, wherein the indication as to whether the received contact information is newer than the previously stored contact information includes a symbol that denotes the received contact information is newer than the previously stored contact information.

7. The method of claim 1, wherein storing the received contact information and the time stamp includes maintaining an indication in the data record of when the previously stored contact information was stored in the data record.

8. A computing device, comprising:
a display;
a memory; and
a processor coupled to the display and the memory, and configured with processor-executable instructions to perform operations for maintaining an information interface for contact information, comprising:
receiving contact information for a field of a data record of an individual or organization having a previously stored data record in a contact database;
determining whether the received contact information for the individual or organization differs from previously stored contact information for the same individual or organization; and
storing, in the data record, the received contact information and a time stamp indicating when the received contact information is stored in response to determining that the received contact information for the individual or organization differs from previously stored contact information for the same individual or organization.

9. The computing device of claim 8, wherein the processor is configured with processor-executable instructions to perform operations further comprising:
generating the time stamp in response to receiving an instruction to store the received contact information in the data record.

10. The computing device of claim 8, wherein the processor is configured with processor-executable instructions to perform operations further comprising:
displaying the received contact information and a value reflecting the time stamp.

11. The computing device of claim 10, wherein the processor is configured with processor-executable instructions to perform operations further comprising:
displaying previous contact information with a corresponding time stamp indicating when the previous contact information was previously stored in the data record together with the received contact information displayed along with the corresponding time stamp.

12. The computing device of claim 8, wherein the processor is configured with processor-executable instructions to perform operations further comprising:
displaying the received contact information with an indication as to whether the received contact information is newer than the previously stored contact information.

13. The computing device of claim 12, wherein the processor is configured with processor-executable instructions to perform operations such that the indication as to whether the received contact information is newer than the previously stored contact information includes a symbol that denotes the contact information is newer than the previously stored contact information.

14. The computing device of claim 8, wherein the processor is configured with processor-executable instructions to perform operations such that storing the received contact information and the time stamp includes maintaining an indication in the data record of when the previously stored contact information was stored in the data record.

15. A non-transitory processor-readable medium having stored thereon processor-executable instructions configured to cause a processor of a computing device to perform operations, for maintaining an information interface for contact information, comprising:
receiving contact information for a field of a data record of an individual or organization having a previously stored data record in a contact database;
determining whether the received contact information for the individual or organization differs from previously stored contact information for the same individual or organization; and
storing, in the data record, the received contact information and a time stamp indicating when the received contact information is stored in response to determining that the received contact information for the individual or organization differs from previously stored contact information for the same individual or organization.

16. The non-transitory processor-readable medium of claim 15, wherein the stored processor-executable instructions are configured to cause the processor of the computing device to perform operations further comprising:
generating the time stamp in response to receiving an instruction to store the received contact information in the data record.

17. The non-transitory processor-readable medium of claim 15, wherein the stored processor-executable instructions are configured to cause the processor of the computing device to perform operations further comprising:
displaying the received contact information and a value reflecting the time stamp.

18. The non-transitory processor-readable medium of claim 17, wherein the stored processor-executable instructions are configured to cause the processor of the computing device to perform operations further comprising:
displaying previous contact information with a corresponding time stamp indicating when the previous contact information was previously stored in the data record together with the received contact information displayed along with the corresponding time stamp.

19. The non-transitory processor-readable medium of claim 15, wherein the stored processor-executable instructions are configured to cause the processor of the computing device to perform operations further comprising:
displaying the received contact information with an indication as to whether the received contact information is newer than the previously stored contact information.

20. The non-transitory processor-readable medium of claim 19, wherein the stored processor-executable instructions are configured to cause the processor of the computing device to perform operations such that the indication as to whether the received contact information is newer than the previously stored contact information includes a symbol that denotes the received contact information is newer than the previously stored contact information.

21. The non-transitory processor-readable medium of claim 15, wherein the stored processor-executable instructions are configured to cause the processor of the computing device to perform operations such that storing the received contact information and the time stamp includes maintaining an indication in the data record of when the previously stored contact information was stored in the data record.

22. A computing device, comprising:
means for receiving contact information for a field of a data record of an individual or organization having a previously stored data record in a contact database;
means for determining whether the received contact information for the individual or organization differs from previously stored contact information for the same the individual or organization; and
means for storing, in the data record, the received contact information and a time stamp indicating when the received contact information is stored in response to determining that the received contact information for the individual or organization differs from previously stored contact information for the same individual or organization.

23. The computing device of claim 22, further comprising:
means for generating the time stamp in response to receiving an instruction to store the received contact information in the data record.

24. The computing device of claim 22, further comprising:
means for displaying the received contact information and a value reflecting the time stamp.

25. The computing device of claim 24, further comprising:
means for displaying previous contact information with a corresponding time stamp indicating when the previous contact information was previously stored in the data record together with received contact information displayed along with the corresponding time stamp.

26. The computing device of claim 22, further comprising:
means for displaying the received contact information with an indication as to whether the received contact information is newer than the previously stored contact information.

27. The computing device of claim 26, wherein the indication as to whether the received contact information is newer than the previously stored contact information includes a symbol that denotes the received contact information is newer than the previously stored contact information.

28. The computing device of claim 22, wherein storing the received contact information and the time stamp includes maintaining an indication in the data record of when the previously stored contact information was stored in the data record.
